(19) United States
(12) Patent Application Publication
(10) Pub. No.: US 2005/0095398 A1
(43) Pub. Date: May 5, 2005

(54) Aqueous base paint and coated article

(75) Inventors: Takashi Watanabe, Hirakata-shi (JP); Seiji Kobayashi, Hirakata-shi (JP); Ikuo Asato, Hirakata-shi (JP)

Correspondence Address: ROBERT J JACOBSON PA, 650 BRIMHALL STREET SOUTH, ST PAUL, MN, 551161511, US

(73) Assignee: Nippon Bee Chemical Co., Ltd.

(21) Appl. No.: 10/966,697

(22) Filed: Oct. 14, 2004

(30) Foreign Application Priority Data
Oct. 29, 2003 (JP) 2003-369588

(51) Int. Cl. B32B 3/10

(52) U.S. Cl. 428/131

(57) ABSTRACT

An object of the present invention is to provide: an aqueous base paint which can form a good coating film under every possible coating environment without needing the humidity control; and a coated article with this paint. As a means of achieving this object, an aqueous base paint according to the present invention comprises as an essential component an aqueous hydrosol resin formed by hydrosolation of an aqueous acrylic resin having an acid value of 15 to 40 mgKOH/g, wherein the content of the aqueous hydrosol resin is not lower than 40 mass % in terms of resin solid component content relative to the entire resin solid components in the paint. In addition, a coated article according to the present invention is coated with the aforementioned aqueous base paint according to the present invention.

### BACKGROUND OF THE INVENTION

A. Technical Field

The present invention relates to: an aqueous base paint usable under every possible environment; and a coated article with this paint.

B. Background Art

Hitherto, a top clear paint has often been overcoated onto a base coating film (formed from a base paint) in order to protect this coating film. For example, on coating lines for such as coating of automobile exteriors and automobile parts, there are conventionally adopted the following: what is called a 3-coat-and-1-bake manner that: a primer paint is coated onto an object to be coated and then its solvent is volatilized to form a primer coating film, and next, a base paint is coated onto this primer coating film and then its solvent is volatilized to form a base coating film, and next, a top clear paint is coated onto this base coating film, and then the resultant multilayers of coating films are processed by baking; and a 2-coat-and-1-bake manner that: a base paint is coated onto an object to be coated and then its solvent is volatilized to form a base coating film, and next, a top clear paint is coated onto this base coating film, and then the resultant multilayers of coating films are baked. Hereupon, as the base paint, it has hitherto been common to use an organic solvent type paint, which is used conventionally in such a manner that: the base paint is coated and then the formed coating film is left at room temperature for several minutes to thereby volatilize the organic solvent, and subsequently the top clear paint is coated.

However, in recent years, while a demand for discharge diminishment of organic solvents is increasing from the viewpoint of the environmental protection, the aforementioned base paint has also come to increasingly be required to be converted from conventional organic solvent type paints into aqueous paints. Thus, there are proposed various aqueous base paints comprising such as water-soluble acrylic resins, acrylic emulsion resins, or urethane-modified acrylic emulsion resins (e.g. refer to such as patent document 1 below).

[Patent Document 1] JP-A-048913/1996 (Kokai)

However, in cases where the prior aqueous paints as described in such as the aforementioned patent document 1 are used as the base paints in the aforementioned 3-coat-and-1-bake manner and 2-coat-and-1-bake manner, there is a problem that the volatilization (vaporization) of water which is a solvent is much influenced by coating environments. Specifically, under a high-humidity atmosphere (e.g. relative humidity=not lower than 80% RH), it is so difficult for the vaporization of water to proceed that it is impossible to increase the viscosity of the coating film, thus resulting in occurrence of sagging during the volatilization (vaporization) of water. On the other hand, under a low-humidity atmosphere (e.g. relative humidity=not higher than 60% RH), the vaporization of water proceeds too fast, so the viscosity unfavorably rises much at a stroke during the coating. As a result, the coating of the paint is so difficult that the surface of the formed coating film has such a rough texture as to bring about the appearance defect. Accordingly, hitherto, in the cases where the aqueous paints are used as the base paints in the aforementioned 3-coat-and-1-bake manner and 2-coat-and-1-bake manner, it has been necessary to take measures of controlling the atmosphere of the coating line in a definite range of humidity, and this has cost a lot.

### SUMMARY OF THE INVENTION

A. Object of the Invention

Thus, an object of the present invention is to provide: an aqueous base paint which can form a good coating film under every possible coating environment without needing the humidity control; and a coated article with this aqueous base paint.

B. Disclosure of the Invention

The present inventors diligently studied to solve the above problems. As a result, they have found out that a specific aqueous hydrosol resin has a property such that its viscosity rises rapidly even due to slight vaporization of water and does not extremely rise even if the vaporization of water proceeds. Then, the present inventors have completed the present invention by confirming that an aqueous paint containing such an aqueous hydrosol resin in a specific amount can solve the aforementioned problems at a stroke.

That is to say, an aqueous base paint according to the present invention comprises as an essential component an aqueous hydrosol resin formed by hydrosolation of an aqueous acrylic resin having an acid value of 15 to 40 mgKOH/g, wherein the content of the aqueous hydrosol resin is not lower than 40 mass % in terms of resin solid component content relative to the entire resin solid components in the paint.

A coated article according to the present invention is coated with the aforementioned aqueous base paint according to the present invention.

C. Effects of the Invention

While meeting the demand for the environmental protection, the aqueous base paint according to the present invention can form a good coating film under every possible coating environment without needing the humidity control and enables great saving of coating costs.

These and other objects and advantages of the present invention will be more fully apparent from the following detailed disclosure.

### DETAILED DESCRIPTION OF THE INVENTION

Hereinafter, detailed descriptions are given about the aqueous base paint according to the present invention and about the coated article according to the present invention. However, the scope of the present invention is not bound to these descriptions. And other than the following illustrations can also be carried out in the form of appropriate modifications of the following illustrations within the scope not departing from the spirit of the present invention.

The aqueous base paint according to the present invention comprises, as an essential component, the specific aqueous hydrosol resin as a vehicle. Hereinafter, detailed descriptions are given about this aqueous hydrosol resin.

The aqueous hydrosol resin in the present invention is formed by the hydrosolation of the aqueous acrylic resin. The aforementioned aqueous hydrosol resin can be obtained, for example, by a process including the steps of carrying out solution polymerization of a polymerizable monomer component to constitute the aqueous acrylic resin and then carrying out the hydrosolation of the resultant resin solution of the aqueous acrylic resin.

The aforementioned polymerizable monomer component to constitute the aqueous acrylic resin will do if it includes an α,β-ethylenically unsaturated monomer having an acid group on condition that such as (meth)acrylic acid and/or a (meth)acrylate is included as an essential component. Incidentally, though not especially limited, the ratio for which the (meth)acrylic acid and/or (meth)acrylate accounts in the aforementioned polymerizable monomer component is favorably not less than 80 mass % of the polymerizable monomer component.

Example of the aforementioned α,β-ethylenically unsaturated monomer having an acid group include (meth)acrylic acid, acrylic acid dimer, crotonic acid, 2-acryloyloxyethylphthalic acid, 2-acryloyloxyethylsuccinic acid, 2-acryloyloxyethyl acid phosphate, 2-acrylamido-2-methylpropanesulfonic acid, ω-carboxy-polycaprolactone mono(meth)acrylate, isocrotonic acid, α-hydro-ω-[(1-oxo-2-propenyl)oxy]poly[oxy(1-oxo-1,6-hexanediyl)], maleic acid, fumaric acid, itaconic acid, 3-vinylsalicylic acid, and 3-vinylacetylsalicylic acid. Among these, the acrylic acid and the methacrylic acid are particularly favorable. The α,β-ethylenically unsaturated monomers having an acid group may be used either alone respectively or in combinations with each other.

The ratio for which the aforementioned α,β-ethylenically unsaturated monomer having an acid group accounts in the polymerizable monomer component will do if it is set appropriately so that the acid value of the resultant aqueous acrylic resin will be in the range of 15 to 40 mgKOH/g as mentioned below.

The aforementioned polymerizable monomer component may include a monomer having a hydroxyl group besides the aforementioned α,β-ethylenically unsaturated monomer having an acid group. Examples of the monomer having a hydroxyl group include hydroxyethyl (meth)acrylate, hydroxypropyl (meth)acrylate, hydroxybutyl (meth)acrylate, allyl alcohol, methallyl alcohol, and addition products from hydroxyethyl (meth)acrylate and ε-caprolactone. The monomers having a hydroxyl group may be used either alone respectively or in combinations with each other.

In the case where the aforementioned polymerizable monomer component further includes the monomer having a hydroxyl group, the ratio for which the aforementioned monomer having a hydroxyl group accounts in the polymerizable monomer component is favorably set so that the hydroxyl group value of the resultant aqueous acrylic resin will be in the range of 20 to 80 mgKOH/g, though not especially limited.

If necessary, the aforementioned polymerizable monomer component may further include another α,β-ethylenically unsaturated monomer besides the aforementioned α,β-ethylenically unsaturated monomer having an acid group. Examples of the above other α,β-ethylenically unsaturated monomer include: (meth)acrylate esters (e.g. methyl (meth)acrylate, ethyl (meth)acrylate, n-butyl (meth)acrylate, isobutyl (meth)acrylate, t-butyl (meth)acrylate, 2-ethylhexyl (meth)acrylate, lauryl methacrylate, phenyl acrylate, isobornyl (meth)acrylate, cyclohexyl methacrylate, t-butylcyclohexyl (meth)acrylate, dicyclopentadienyl (meth)acrylate, and dihydrodicyclopentadienyl (meth)acrylate); polymerizable amide compounds (e.g. (meth)acrylamide, N-methylol(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, and N-(2-hydroxyethyl)(meth)acrylamide); polymerizable aromatic compounds (e.g. styrene, α-methylstyrene, vinyl ketone, t-butylstyrene, p-chlorostyrene, and vinylnaphthalene); polymerizable nitriles (e.g. (meth)acrylonitrile); α-olefin (e.g. ethylene and propylene); vinyl esters (e.g. vinyl acetate and vinyl propionate); and dienes (e.g. butadiene and isoprene). The above other α,β-ethylenically unsaturated monomers may be used either alone respectively or in combinations with each other.

In the case where the polymerizable monomer component further includes the aforementioned other α,β-ethylenically unsaturated monomer, the ratio for which this other α,β-ethylenically unsaturated monomer accounts in the polymerizable monomer component is favorably set in the range of 92 to 98 mass % of the polymerizable monomer component, though not especially limited.

Though not especially limited, examples of polymerization initiators usable in the aforementioned solution polymerization to obtain the aqueous acrylic resin include: azo polymerization initiators (e.g. azobisisobutyronitrile); and peroxide polymerization initiators (e.g. benzoyl peroxide, p-chlorobenzoyl peroxide, lauroyl peroxide, and t-butyl perbenzoate). The polymerization initiators may be used either alone respectively or in combinations with each other. Incidentally, in the aforementioned polymerization, it is also possible that, when the occasion demands, chain transfer agents (e.g. mercaptans (e.g. laurylmercaptan) and α-methylstyrene dimer) are used for the purpose of adjusting the molecular weight.

In the aforementioned solution polymerization to obtain the aqueous acrylic resin, it is possible to use, as solvents, for example, the following: aromatic hydrocarbons (e.g. toluene and xylene); aliphatic hydrocarbons (e.g. hexane, heptane, and octane); esters (e.g. ethyl acetate, n-butyl acetate, isobutyl acetate and amyl acetate); ethers (e.g. propylene glycol monomethyl ether); ketones; alcohols or their derivatives; ethylene glycol, propylene glycol, diethylene glycol, triethylene glycol, or their derivatives; and dioxane, N-methylpyrrolidone, and dimethylformamide. The solvents may be used either alone respectively or in combinations with each other.

Though not especially limited, the process for the aforementioned solution polymerization will do, for example, if it includes the following steps of: charging a reactor with the solvent; and then heating the solvent to a prescribed reaction temperature; and then dropping the polymerizable monomer component and the polymerization initiator into the reactor at the above temperature; and then carrying out the polymerization at a constant temperature for a prescribed time. In this process, the reaction temperature is favorably set in the range of 100 to 120° C., and the reaction time is favorably set in the range of about 5 to about 8 hours.

It is important that the acid value of the aforementioned aqueous acrylic resin is in the range of 15 to 40 mgKOH/g. Because the aqueous base paint according to the present invention comprises as an essential component the aqueous hydrosol resin formed by hydrosolation of the aqueous acrylic resin having such a specific acid value, the aqueous base paint according to the present invention can be applied under every possible coating environment without the humidity control, though being an aqueous paint. The acid value of the aforementioned aqueous acrylic resin is favorably in the range of 20 to 30 mgKOH/g. In the case where the acid value of the aqueous acrylic resin is less than 15 mgKOH/g, it is impossible to obtain the aqueous hydrosol resin actually as an aqueous one, thus resulting in failure to obtain the aqueous paint. On the other hand, in the case where the acid value of the aqueous acrylic resin is more than 40 mgKOH/g, there is obtained a paint such that: under a high-humidity environment, the sagging tends to occur and, under a low-humidity environment, the coating is difficult.

Though not especially limited, the weight-average molecular weight of the aforementioned aqueous acrylic resin is, for example, favorably in the range of 15,000 to 100,000.

The process for the hydrosolation of the aforementioned aqueous acrylic resin can be carried out by hitherto publicly known processes without especial limitation. For example, it will do to adopt such as: 1) a process in which the resin solution of the aqueous acrylic resin, obtained by the aforementioned polymerization, is added into a receptacle containing a neutralizing agent and water to forcedly disperse the resin solution into water; 2) a process in which the neutralizing agent is added to the aforementioned resin solution to thus neutralize it, and then the resultant neutralized resin solution is dispersed into water while added into a water-containing receptacle under stirring; and 3) a process in which the neutralizing agent is added to the aforementioned resin solution to thus neutralize it, and then high-temperature water is gradually added to the resultant neutralized resin solution while this solution is a little heated under stirring, whereby the phase is reversed to thus disperse the resin solution into water. Incidentally, the ratio among the aforementioned resin solution, neutralizing agent, and water, which are used in the hydrosolation of the aforementioned aqueous acrylic resin, is favorably in the range of (amount of resin solution)/(total amount of neutralizing agent and water) (mass ratio)=10/15 to 10/30.

The aforementioned neutralizing agent being used for the hydrosolation of the aforementioned aqueous acrylic resin is not especially limited. Usable examples thereof include organic amine compounds (e.g. primary amines, secondary amines, and tertiary amines) and ammonia water. Specific examples of the organic amine compounds include alkylamines (e.g. monoethylamine, diethylamine, triethylamine, and tributylamine) and alkanolamines (e.g. monoethanolamine, diethanolamine, dimethylethanolamine, and methylpropanolamine). The neutralizing agents may be used either alone respectively or in combinations with each other.

Though not especially limited, the resin solid component content of the aforementioned aqueous hydrosol resin is favorably in the range of 20 to 35 mass %.

It is important that the content for which the aforementioned aqueous hydrosol resin accounts in the aqueous base paint according to the present invention is not lower than 40 mass % in terms of resin solid component content relative to the entire resin solid components in the paint. Favorably, this content is in the range of 50 to 80 mass % in terms of resin solid component content relative to the entire resin solid components in the paint. In the case where the aqueous hydrosol resin content is lower than 40 mass %, there is obtained a paint such that: under a high-humidity environment, the sagging tends to occur and, under a low-humidity environment, the coating is difficult.

The aqueous base paint according to the present invention may be such as comprises, as a vehicle, another aqueous resin besides the aforementioned aqueous hydrosol resin in the range of not higher than 60 mass % in terms of resin solid component content relative to the entire resin solid components in the paint. Examples of the aqueous resin other than the aforementioned aqueous hydrosol resin include urethane dispersions, melamine resins, and acrylic emulsion resins.

Into the aqueous base paint according to the present invention, there can be formulated a pigment. Examples of this pigment include: inorganic pigments (e.g. titanium oxide, carbon black, iron oxide pigments, chromium oxide); organic pigments (e.g. azo pigments, anthracene pigments, perylene pigments, quinacridone pigments, indigo pigments, phthalocyanine pigments, isoindolinone pigments); metallic pigments (e.g. aluminum pigments (e.g. coating aluminum), metal-made shining materials (which may be either non-colored ones or colored ones) such as metals or alloys (e.g. copper, zinc, nickel, tin, and aluminum oxide)); mica pigments; extenders (e.g. talc, precipitated barium sulfate, silicates); and conductive pigments (e.g. conductive carbon). The pigments may be used either alone respectively or in combinations with each other. If the pigment is formulated, then its content is favorably set in the range of 5 to 70 mass % relative to the entire resin solid components in the paint. In the case where the pigment content is lower than 5 mass %, the coloring power is so low that the hiding power is insufficient. On the other hand, in the case where the pigment content is higher than 70 mass %, there is a possibility that the smoothness and adhesion of the resultant coating film may be inferior. Incidentally, if the metallic pigment (e.g. aluminum pigment) is used as the aforementioned pigment, then, in order that the metal (e.g. aluminum) can be prevented from corroding due to oxidation to thus precipitate and aggregate or come to display no metal gloss when the coating film has been formed, it is favorable to beforehand take measures such as of subjecting the above metallic pigment to chromate treatment or to treatment with an antioxidant or separately adding the antioxidant for metals to the paint. Hereupon, usable examples of the antioxidant include organophosphorus compounds (e.g. lauryl phosphate and high-molecular acryl phosphate), and its amount being used may be set appropriately within the range not damaging the effects of the present invention.

The aqueous base paint according to the present invention contains water as the main solvent. However, this paint may further contain an organic solvent as another solvent if its amount is not larger than 50 mass % relative to water. Examples of this organic solvent include those which are aforementioned as examples of solvents usable in the polymerization to obtain the aqueous acrylic resin. The organic solvents may be used either alone respectively or in combinations with each other.

If necessary, within the range not damaging the effects of the present invention, the aqueous base paint according to the present invention may further contain, for example, additives (e.g. thickeners, defoamers, lubricants (e.g. fluorinated lubricants), pigment dispersants, surface conditioners, leveling agents, ultraviolet absorbing agents, antioxidants, antiseptics, antimolds, plasticizers, conductive materials, electromagnetic-wave-absorbent materials, odorous-substance-absorbing agents).

The aqueous base paint according to the present invention can be obtained by uniformly mixing the aforementioned components by conventional methods. For example, it will do to, under stirring, add the aforementioned components one by one or all at once into a container equipped with a stirrer, thus uniformly mixing them together. In addition, as to the pigment, it may be beforehand dispersed into a part or the whole of the vehicle to a necessary level to thus form a pigment paste and then added.

The aqueous base paint according to the present invention, favorably, has a pH of 7 to 9. If necessary, within the range not damaging the effects of the present invention, the aqueous base paint according to the present invention may be pH-adjusted with the aforementioned neutralizing agent (which is used for the hydrosolation of the aforementioned aqueous acrylic resin) as a pH-adjusting agent.

The aqueous base paint according to the present invention may be coated either directly onto an object to be coated or onto a primer coating film (as an undercoat) having beforehand been formed on the object to be coated.

There is no especial limitation on the coating method when coating the aqueous base paint according to the present invention. It is possible to adopt publicly known methods such as air spray coating, rotary disk coating, dip coating, and brush coating. In addition, the transfer efficiency may be enhanced by applying the electro-static-spray when the coating is carried out.

The coating amount, when coating the aqueous base paint according to the present invention, may be set appropriately for its uses and is therefore not especially limited. However, it is recommended that the coating amount should be set so that the resultant dried film thickness will be in the range of 5 to 30 μm, favorably 10 to 25 μm. In the case where the dried film thickness is too thin, there is a possibility that the color of the object to be coated cannot completely be hidden, and further, it is difficult to obtain a smooth coating film. On the other hand, in the case where the dried film thickness is too thick, popping tends to occur, or the orientation of the metallic pigment tends to get out of order to thus result in deterioration of the brilliant feeling.

If the aqueous base paint according to the present invention is left for about several minutes after having been coated, then this paint can be overcoated with the top clear paint to thereby form multilayers of coating films comprising a base coating film and a top clear coating film. On this occasion, even if the coating is carried out under an environment ranging widely from a low humidity to a high humidity without carrying out the humidity control, a good coating film can be formed without the occurrence of the sagging or the difficulty of the coating.

The aforementioned top clear paint may be in any form of such as a solvent type paint, an aqueous paint, and a powder paint and is therefore not especially limited. For example, it is possible to use publicly known top clear paints such as 1-package polyurethane paints, 2-package polyurethane paints, melamine resin curing paints, and acid-epoxy curing paints.

As to the aforementioned top clear paint, its coating method and amount may be set appropriately and is therefore not especially limited. For example, as the coating method, it is possible to adopt the methods aforementioned as the coating methods for coating the aqueous base paint according to the present invention. As to the coating amount, in the case where the dried film thickness is too thin, such as appearance defect or durability deterioration tends to occur. On the other hand, in the case where the dried film thickness is too thick, the sagging tends to occur to thus put the coating operation in bad condition. Therefore, it is recommended that the coating amount should be set so that the resultant dried film thickness will be in the range of 10 to 60 μm, favorably 20 to 50 μm.

The multilayers of coating films, comprising the base coating film (formed from the aqueous base paint according to the present invention) and the top clear coating film (formed from the aforementioned top clear paint), will do if it is baked simultaneously. As to conditions in the baking, for example, in the case where the 1-package polyurethane paint or 2-package polyurethane paint is used as the top coating paint, it is favorable that the heating is carried out in the range of room temperature to 140° C. In the case where the melamine resin curing paint or acid-epoxy curing paint is used as the top coating paint, it is favorable that the heating is carried out in the range of 100 to 140° C. The heating time is favorably set in the range of 5 to 60 minutes, though depending on the temperature.

The coated article according to the present invention is coated with the aforementioned aqueous base paint according to the present invention. That is to say, the coated article according to the present invention is an article which is provided at least with: a substrate as the object of the coating (object to be coated); and a coating film formed on the surface of the above substrate from the aqueous base paint according to the present invention in the aforementioned way.

The substrate as the object to be coated is not especially limited. However, various plastic materials are favorable. Examples thereof include polyolefins (e.g. polypropylene (PP) and polyethylene (PE)), and besides, acrylonitrile-styrene (AS), acrylonitrile-butadiene-styrene (ABS), poly(phenylene oxide) (PPO), poly(vinyl chloride) (PVC), polyurethane (PU) and polycarbonate (PC), or their polymer alloys.

The coated article according to the present invention can favorably be used, for example, as an automobile plastic part and, particularly, is favorably used, for example, as a part for exterior panels (e.g. bumper, back door, locker panel, door mirror, fender). These are favorable to coat with the aqueous base paint according to the present invention. The resultant coated articles are excellent in such as appearance and general performance.

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to them. Hereinafter, unless otherwise noted, the units “mass part(s)” and “mass %” are referred to simply as “part(s)” and “%” respectively.

### PRODUCTION EXAMPLE 1

### Production of Aqueous Hydrosol Resin

An amount of 27.14 parts of propylene glycol monomethyl ether (PGME) (this is referred to as component A) was charged into a reactor as equipped with a stirrer, a thermometer, a reflux condenser, dropping funnels, a nitrogen-introducing tube, and a heater with a thermostat. Then, the inner temperature was heated to 110° C. and the stirring was started. Next, a monomer solution (comprising 2.3 parts of methacrylic acid (MAA), 14.49 parts of hydroxyethyl acrylate (HEA), 20.89 parts of methyl methacrylate (MMA), 52.32 parts of ethyl acrylate (EA), and 10 parts of styrene monomer (St)) (this is referred to as component B) and a polymerization initiator solution (comprising 2.2 parts of a peroxide polymerization initiator (“Kayaester O” produced by Nippon Kayaku Co., Ltd.) and 10 parts of propylene glycol monomethyl ether (PGME)) (this is referred to as component C) were dropped over a period of 3 hours each to start the polymerization, while the inner temperature was kept at 110° C. Then, while the inner temperature of 110° C. was still kept after the end of the dropping, a solution (comprising 0.3 part of a peroxide polymerization initiator (“Kayaester O” produced by Nippon Kayaku Co., Ltd.) and 5 parts of propylene glycol monomethyl ether (PGME)) (this is referred to as component D) was dropped over a period of 2 hours to end the polymerization, thus obtaining a resin solution of an aqueous acrylic resin. The acid value (having been determined by the KOH solution titration method) and weight-average molecular weight (having been measured by gel permeation chromatography (GPC)) of this aqueous acrylic resin were as shown in Table 1.

Next, the inner temperature of the resin solution was dropped to 50° C., and then thereto 2.36 parts of dimethylethanolamine (DMEA) (this is referred to as component E) was added to neutralize carboxyl groups of the resin, and then further thereto 190.5 parts of deionized water of 50° C. (this is referred to as component F) was dropwise added over a period of 15 minutes, thereby reversing the polymer phase to form a hydrosol, thus obtaining an aqueous hydrosol resin (1).

The resin solid component content of the resultant aqueous hydrosol resin was determined in the following way. Its result was as shown in Table 1.

<Measurement of Resin Solid Component Content>:

An amount of (x) g of aqueous hydrosol resin was dried at 110° C. for 3 hours, and then the residual solid component amount (y) g was measured to make a calculation by the following equation.
Resin solid component content (%)=[(y)/(x)]×100

### PRODUCTION EXAMPLES 2 TO 8

### Production of Aqueous Hydrosol Resins

Aqueous hydrosol resins (2) to (7) were obtained in the same way as of Production Example 1 except that the amounts of the components A to F in Production Example 1 were changed as shown in Table 1. Incidentally, in Production Example 8, the hydrosolation was impossible. The acid value and weight-average molecular weight of the aqueous acrylic resin and the resin solid component content of the aqueous hydrosol resin in each Production Example are shown in Table 1.

Incidentally, in Table 1, the following abbreviations are used.
PGME: propylene glycol monomethyl ether
MAA: methacrylic acid
HEA: hydroxyethyl acrylate
MMA: methyl methacrylate
EA: ethyl acrylate
St: styrene monomer
Kayaester O: peroxide polymerization initiator (“Kayaester O” produced by Nippon Kayaku Co., Ltd.)

DMEA: dimethylethanolamine

TABLE 1

| | | Production | Production | Production | Production | Production | Production | Production | Production |
|---|---|---|---|---|---|---|---|---|---|
| | | Example 1 | Example 2 | Example 3 | Example 4 | Example 5 | Example 6 | Example 7 | Example 8 |
| Component A | PGME | 27.14 | 27.14 | 27.14 | 27.14 | 27.14 | 27.14 | 27.14 | 27.14 |
| Component B | MAA | 2.3 | 3.07 | 3.07 | 4.6 | 4.6 | 6.14 | 7.67 | 1.54 |
| | HEA | 14.49 | 14.49 | 14.49 | 14.49 | 14.49 | 14.49 | 14.49 | 14.49 |
| | MMA | 20.89 | 19.86 | 19.86 | 17.79 | 17.79 | 15.73 | 13.67 | 21.92 |
| | BA | 52.32 | 52.58 | 52.58 | 53.12 | 53.12 | 53.64 | 54.17 | 52.05 |
| | St | 10 | 10 | 10 | 10 | 10 | 10 | 10 | 10 |
| Component C | Kayaester O | 2.2 | 1 | 0.7 | 1.5 | 0.6 | 4 | 2.2 | 2.2 |
| | PGME | 10 | 10 | 10 | 10 | 10 | 10 | 10 | 10 |
| Component D | Kayaester O | 0.3 | 0.2 | 0.2 | 0.3 | 0.2 | 0.3 | 0.3 | 0.3 |
| | PGME | 5 | 5 | 5 | 5 | 5 | 5 | 5 | 5 |
| Component E | DMEA | 2.36 | 3.14 | 3.14 | 4.71 | 4.71 | 6.28 | 7.85 | 1.57 |
| Component F | Deionized | 190.5 | 191.02 | 191.32 | 188.85 | 189.85 | 184.78 | 185.01 | 191.29 |
| | water | | | | | | | | |

| | | | | | | | | |
|---|---|---|---|---|---|---|---|---|
| Acid value (mgKOH/g) | 15 | 20 | 20 | 30 | 30 | 40 | 50 | 10 |
| Weight-average molecular | 25000 | 60000 | 80000 | 40000 | 100000 | 15000 | 25000 | 25000 |
| weight | | | | | | | | |
| Resin solid component | 30 | 30 | 30 | 30 | 30 | 30 | 30 | — |
| content (%) | | | | | | | | |

### EXAMPLE 1

An amount of 100 parts of the aqueous hydrosol resin (1) (as the vehicle) was charged into a container as equipped with a stirrer. Next, 4 parts of coating aluminum (“Hydromer 2192” produced by Eckart) (as the pigment) was added thereto under stirring. When the aluminum particles became sufficiently disentangled, there were further added 1.25 parts of a defoamer (“Surfynol 440” produced by Air Products Co., Ltd.), 0.07 part of a fluorinated lubricant (“EF 112” produced by JEMCO Inc.), 0.08 part of an organophosphorus compound (“JP-518-0” produced by JOHOKU CHEMICAL Co., Ltd.), 0.47 part of a thickener (“Acrysol ASE-60” produced by Rohm & Haas Company), 0.31 part of dimethylethanolamine (DMEA) (as the pH-adjusting agent), and 33.82 parts of deionized water in that order under stirring. After the addition of all the above materials had been completed, the stirring was continued for another 1 hour, thus obtaining an aqueous base paint.

The resultant aqueous base paint was adjusted to a viscosity of 40 seconds/#4 Ford Cup·20° C. to carry out the following evaluations. Their results are shown in Table 2.

First of all, a hole of 5 mm in diameter was made through a commercially available polypropylene material (70 mm×150 mm×3 mm), and then this material was 1-stage-coated with an aqueous primer paint for polypropylene materials (“WB 8200” produced by NIPPON BEE CHEMICAL CO., LTD.) by a spray gun (“W-71” produced by ANEST IWATA Corporation) so that the resultant dried film thickness would be 10 μm. Then, they were heat-dried at 80° C. for 10 minutes, thereby preparing an adherend for the evaluations.

Next, the aforementioned adherend was vertically set under each of three coating environments having been set at different humidities (namely, an atmosphere of 20° C. and 85% RH in relative humidity as the high-humidity environment, an atmosphere of 25° C. and 70% RH in relative humidity as the intermediate-humidity environment, and an atmosphere of 30° C. and 55% RH in relative humidity as the low-humidity environment) and then 2-stage-coated with the aqueous base paint (to be subjected to the evaluations) by a spray gun (“W-71” produced by ANEST IWATA Corporation) so that the resultant dried film thickness would be 15 μm. Thereby specimens were obtained. These specimens were left under the above environments for 1 minute after the above coating. Immediately thereafter, in order to promote the sagging, the specimens were placed into a drying oven of 80° C. and left in the vertically set state for 1 minute and then left at room temperature for 5 minutes. Then, at that point of time, a lower portion of the hole of each specimen was observed with the eye to evaluate whether there was any sagging of the aqueous base paint or not (a case where there was no sagging was judged ◯, and a case where there was sagging was judged X). And besides, the coating film surface of each specimen was observed with the eye to evaluate the smoothness of the coating film surface (a case where no rough texture was seen on the surface was judged ◯, and a case where a rough texture was seen on the surface was judged X).

### EXAMPLES 2 TO 9 AND COMPARATIVE EXAMPLES 1 TO 3

Aqueous base paints were obtained in the same way as of Example 1 except that the mixing composition in Example 1 was changed to those shown in Tables 2 and 3. Incidentally, in Examples 7 to 9 and Comparative Examples 2 to 3, a urethane dispersion (“NeoRez R972” produced by Avecia Co., Ltd.; resin solid component content 34%) and/or a melamine resin (“Cymel 303” produced by MITSUI CYTEC LTD.; resin solid component content 100%) as well as the aqueous hydrosol resin was used as the vehicle.

The same evaluations as of Example 1 were carried out with the resultant aqueous base paints. Their results are shown in Tables 2 and 3.

### COMPARATIVE EXAMPLE 4

The same evaluations as of Example 1 were carried out with a commercially available aqueous base paint (“WB 5100” produced by NIPPON BEE CHEMICAL CO., LTD.) containing no aqueous hydrosol resin. Their results are shown in Table 3.

TABLE 2

| | | Example 1 | Example 2 | Example 3 | Example 4 | Example 5 | Example 6 | Example 7 | Example 8 | Example 9 |
|---|---|---|---|---|---|---|---|---|---|---|
| Mixing | Aqueous hydrosol resin (1) | 100 | — | — | — | — | — | — | — | — |
| composition/ | Aqueous hydrosol resin (2) | — | 100 | — | — | — | — | 70 | — | — |
| parts | Aqueous hydrosol resin (3) | — | — | 100 | — | — | — | — | — | — |
| | Aqueous hydrosol resin (4) | — | — | — | 100 | — | — | — | 50 | 40 |
| | Aqueous hydrosol resin (5) | — | — | — | — | 100 | — | — | — | — |
| | Aqueous hydrosol resin (6) | — | — | — | — | — | 100 | — | — | — |
| | Urethane dispersion | — | — | — | — | — | — | 26.47 | 26.47 | 35.29 |
| | Melamine resin | — | — | — | — | — | — | — | 6 | 6 |
| | Coating aluminum | 4 | 4 | 4 | 4 | 4 | 4 | 4 | 4 | 4 |
| | Defoamer | 1.25 | 1.25 | 1.25 | 1.25 | 1.25 | 1.25 | 1.25 | 1.25 | 1.25 |
| | Fluorinated lubricants | 0.07 | 0.07 | 0.07 | 0.07 | 0.07 | 0.07 | 0.07 | 0.07 | 0.07 |
| | Organophosphorus | 0.08 | 0.08 | 0.08 | 0.08 | 0.08 | 0.08 | 0.08 | 0.08 | 0.08 |
| | compound | | | | | | | | | |
| | Thickener | 0.47 | 0.47 | 0.47 | 0.47 | 0.47 | 0.47 | 0.47 | 0.47 | 0.47 |
| | Dimethylethanolamine | 0.31 | 0.31 | 0.31 | 0.31 | 0.31 | 0.31 | 0.31 | 0.31 | 0.31 |
| | Deionized water | 33.82 | 33.82 | 33.82 | 33.82 | 33.82 | 33.82 | 37.35 | 51.35 | 52.53 |

| Aqueous hydrosol resin content (%)*1 | | | 100 | 100 | 100 | 100 | 100 | 100 | 70 | 50 | 40 |
|---|---|---|---|---|---|---|---|---|---|---|---|
| Evalua- | Sagging/ | 20° C., 85% RH | ◯/◯ | ◯/◯ | ◯/◯ | ◯/◯ | ◯/◯ | ◯/◯ | ◯/◯ | ◯/◯ | ◯/◯ |
| tions | smooth- | 25° C., 70% RH | ◯/◯ | ◯/◯ | ◯/◯ | ◯/◯ | ◯/◯ | ◯/◯ | ◯/◯ | ◯/◯ | ◯/◯ |
| | ness | 30° C., 55% RH | ◯/◯ | ◯/◯ | ◯/◯ | ◯/◯ | ◯/◯ | ◯/◯ | ◯/◯ | ◯/◯ | ◯/◯ |

*1Aqueous hydrosol resin solid component content relative to the entire resin solid components

TABLE 3

| | | Comparative | Comparative | Comparative | Comparative |
|---|---|---|---|---|---|
| | | Example 1 | Example 2 | Example 3 | Example 4 |
| Mixing | Aqueous hydrosol resin (2) | — | 35 | — | |
| composition/ | Aqueous hydrosol resin (5) | — | — | 35 | |
| parts | Aqueous hydrosol resin (7) | 100 | — | — | |
| | Urethane dispersion | — | 57.35 | 39.71 | |
| | Melamine resin | — | — | 6 | |
| | Coating aluminum | 4 | 4 | 4 | |
| | Defoamer | 1.25 | 1.25 | 1.25 | |
| | Fluorinated lubricants | 0.07 | 0.07 | 0.07 | |
| | Organophosphorus compound | 0.08 | 0.08 | 0.08 | |
| | Thickener | 0.47 | 0.47 | 0.47 | |
| | Dimethylethanolamine | 0.31 | 0.31 | 0.31 | |
| | Deionized water | 33.82 | 41.47 | 53.11 | |

| Aqueous hydrosol resin content (%)*1 | | | 100 | 35 | 35 | 0 |
|---|---|---|---|---|---|---|
| Evaluations | Sagging/ | 20° C., 85% RH | X/◯ | X/◯ | X/◯ | X/◯ |
| | smoothness | 25° C., 70% RH | ◯/◯ | ◯/◯ | ◯/◯ | ◯/◯ |
| | | 30° C., 55% RH | ◯/◯ | ◯/X | ◯/X | ◯/X |

*1Aqueous hydrosol resin solid component content relative to the entire resin solid components

### INDUSTRIAL APPLICATION

The aqueous base paint according to the present invention is usable favorably on the coating lines of overcoating the top clear paint after having coated the base paint, for example, like in the 3-coat-and-1-bake manner and 2-coat-and-1-bake manner. Specifically, for example, the aqueous base paint according to the present invention is usable favorably on coating lines for such as coating of automobile exteriors (e.g. bumpers).

Various details of the invention may be changed without departing from its spirit not its scope. Furthermore, the foregoing description of the preferred embodiments according to the present invention is provided for the purpose of illustration only, and not for the purpose of limiting the invention as defined by the appended claims and their equivalents.

1. An aqueous base paint, which comprises as an essential component an aqueous hydrosol resin formed by hydrosolation of an aqueous acrylic resin having an acid value of 15 to 40 mgKOH/g, wherein the content of the aqueous hydrosol resin is not lower than 40 mass % in terms of resin solid component content relative to the entire resin solid components in the paint.

2. A coated article, which is coated with the aqueous base paint as recited in claim 1.
